(19) United States
(12) Patent Application Publication
(10) Pub. No.: US 2005/0017641 A1
(43) Pub. Date: Jan. 27, 2005

(54) Lamp comprising a lamp body and line feed, which is guided along the exterior of the lamp body, and method for producing the lamp

(76) Inventors: Ursus Kruger, Berlin (DE); Raymond Ullrich, Schonwalde (DE)

Correspondence Address: YOUNG & THOMPSON, 745 SOUTH 23RD STREET, 2ND FLOOR, ARLINGTON, VA, 22202, US

(21) Appl. No.: 10/488,355

(22) PCT Filed: Aug. 28, 2002
(86) PCT No.: PCT/DE02/03195

(30) Foreign Application Priority Data
Aug. 30, 2001 (DE) 101 43 714.5

(51) Int. Cl. H01J 17/18; H01J 61/36

(52) U.S. Cl. 313/623; 313/624; 313/625

(57) ABSTRACT

The invention relates to a lamp, particularly a high-pressure discharge lamp, comprising a base (24), whereby an upper electric connection (28b) is contacted by a return conductor (27) running along a lamp body (14), and to a method for producing a lamp of this type. According to the invention, the return conductor (27) is provided by a conducting layer (17), which is applied using vacuum technology, in particular, sputtering and which is directly located on the lamp body (14). This results in reducing manufacturing costs associated with the mounting of an isolated return conductor (27) running parallel to the lamp body (14). In addition, the lamp produced in the aforementioned manner reliably functions by virtue of the fact that the conducting layer (17) is not affected by vibrations. This lamp can be used, for example, for headlamps of a motor vehicle.

The invention relates to a lamp, in particular a high-pressure discharge lamp, having a lamp body which surrounds a luminous element having two terminals, a first line feed running into the lamp body to one of the two terminals, and a second line feed being guided along the exterior of the lamp body to the other of the two terminals.

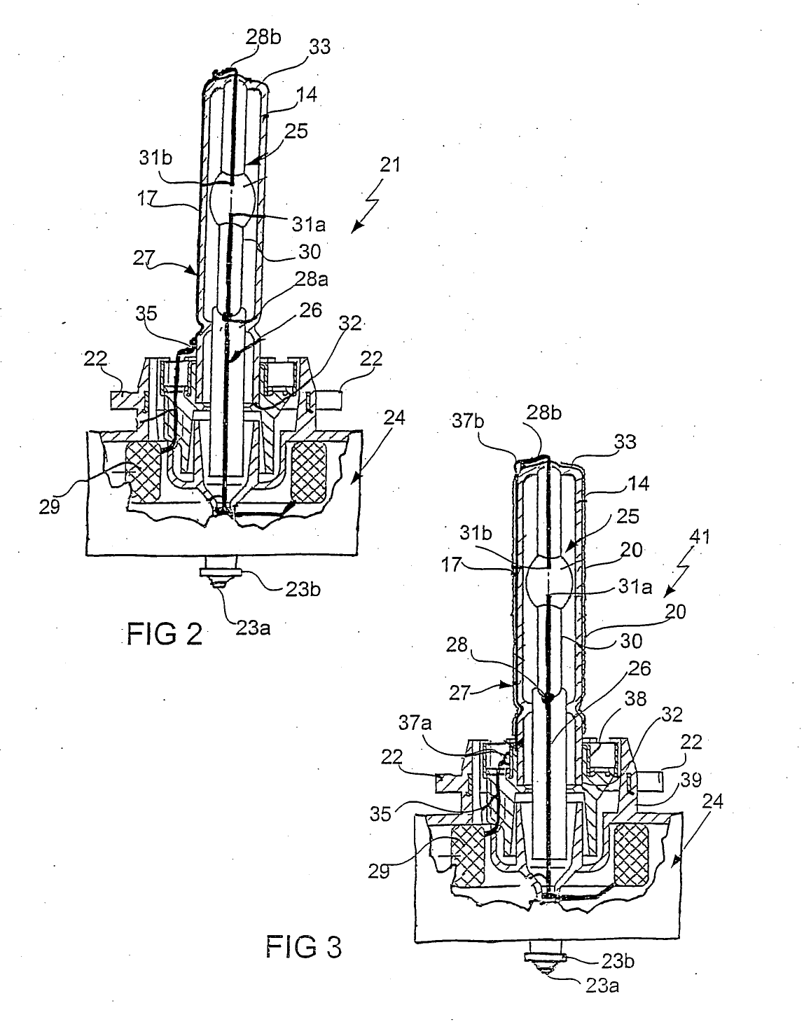

A lamp of this type, as may be used for headlamps in motor vehicles, may be seen, for example, in FIG. 2 of DE 198 03 139 A1. Such a lamp has an elongate lamp body in which a so-called burner is accommodated as the luminous element, and the luminescence of the lamp is produced by a gas discharge in this burner. This burner has two electrodes which are guided out of the luminous element as terminals at the top and bottom end of the lamp body. The bottom end of the lamp body is fixed in a base which is suitable for installation in a headlamp for motor vehicles. The terminal at the bottom end is connected to a first line feed which is integrated in the base. The terminal at the top end, which is remote from the base, has to be electrically connected to the base. This takes place by means of an insulated, second line feed, which runs parallel to the lamp body and is in contact with a connecting terminal in the base, and, at the top end of the lamp body, with the terminal which is situated there. The insulation of the second line feed prevents short circuits and flashovers when the high-pressure discharge lamp is supplied with a high voltage.

The object of the invention is to provide a lamp which can be produced in a comparatively cost-effective manner, and whose operation is particularly reliable.

The object is achieved according to the invention in the case of a lamp of the type mentioned initially by the second line feed being a conductive layer on the lamp body which is applied using the vacuum coating technique. The conductive layer renders superfluous complex installation steps which would be required to apply a separate, second line feed and thus improves the cost-effectiveness of the production method. In addition, the conductive layer is insensitive to vibrations since it lies directly on the lamp body. Vibrations, as may occur in the case of a free-standing, second line feed, are avoided. Loose contacts are thus prevented from being formed, and the operational reliability of the lamp is thus increased.

The electrical resistance of the conductive layer may be set in a simple manner by the layer geometry, that is the width and the thickness of the layer. In particular for high-pressure discharge lamps, only small cross sections need be used here, since these have a high voltage applied to them, resulting in low currents.

The conductive layer may be made of various conductive materials; for example, it may be made of a noble metal such as gold, which has the advantage that the conductive layer need not be subjected to any subsequent processing steps for corrosion protection. However, the material costs of the layer material are very high.

However, the conductive layer is particularly advantageously made of a metal which can be passivated in air, such as aluminum. This also makes it possible to avoid reworking of the conductive layer, since a passivation layer forms spontaneously on the conductive layer in air. This passivation layer at the same time insulates the conductive layer, as a result of which short circuits or flashovers owing to the high voltage can be prevented. The selection of aluminum is suitable for the described application primarily since this metal combines good conductivity with the ability to form a dense passivation layer. In addition, aluminum is relatively inexpensive. However, the electrical insulation capability of the spontaneously formed passivation layer is limited owing to the layer thickness that can be achieved.

However, according to another refinement of the invention, the conductive layer may also be provided with an electrical insulating layer, whose layer thickness can be influenced by the coating process. The layer thickness and the selection of the coating material may be used to produce the desired insulating effect. The insulating layer may consist of, for example, a metal oxide, which is likewise applied using the sputtering method or another vacuum coating method. However, other application methods are also conceivable, for example enamel coating. For the conductive layer, metals having good electrical conductivity may be selected, which can also be obtained inexpensively, without it being necessary to take good corrosion resistance into account in the selection.

It is particularly cost-effective for the insulating layer to consist of a material which is intended to be applied to the lamp body in any case owing to other requirements for the lamp. In addition to fulfilling these other requirements, this coating must also ensure the electrical insulation of the conductive layer. In this case, the insulating layer is also applied at least to parts of the lamp body which do not have a conductive layer but which need to be coated owing to another function required of them. Examples of other functions are a UV barrier layer, which can be formed from cerium oxide and absorbs the UV radiation emitted by the lamp, an IR reflector layer, which reduces the thermal radiation from the lamp and in this manner increases the operating temperature of the lamp in an advantageous manner, or an optical covering layer, which may be formed, for example, from iron oxide or copper oxide and prevents the propagation of stray radiation.

According to one advantageous refinement of the invention, the lamp body is held in a base by means of a first end and the first line feed, and the conductive layer runs to a connecting terminal in the base. This lamp design advantageously makes it possible for it to be installed, for example, in the headlamp of a motor vehicle or else in another illumination device having a receptacle for the lamp which fits the base.

One advantageous possibility of saving on additional method steps for making electrical contact consists in the electrical connection between the conductive layer and the connecting terminal located in the base being formed by a plug connection which needs to be provided in any case for producing the connection between the base and the lamp body. In this case, the conductive layer is applied to the lamp body such that it is electrically connected to the connecting terminal in the base, which is formed as a contact region, in the region of the plug connection. Then, the lamp body can be fixed in the base in a known manner, for example by adhesive bonding, it being necessary to maintain the electrical contact between the conductive layer and the contact region located in the base.

According to one advantageous refinement of the invention, the electrical connection between the conductive layer, on the one hand, and the other of the terminals and/or the connecting terminal, on the other hand, is formed by a soldered or welded joint.

In this case, the conductive layer forms a soldering surface on the lamp body and, for example, the other terminal, which may be a wire, is bent toward this soldering surface. Then, a soldering point may be formed which joins the end of the wire to the soldering surface. In this manner, it is possible for cost-effective and reliable electrical contact to be made. The same method may be used for the connecting terminal.

A welded joint between the conductive layer and, for example, the other terminal may be produced by means of laser welding. The laser beam is used to fuse the conductive layer and the other terminal, as a result of which, following the subsequent solidification process, a strong join between the welding partners makes the contact. The same method may be used for the connecting terminal.

However, it is particularly advantageous if the electrical contact between the other terminal and/or the connecting terminal, on the one hand, and the conductive layer located on the lamp body, on the other hand, is formed by the conductive layer also being applied to the adjoining part, for example, of the other terminal. For this purpose, it is necessary for the adjoining part of the other terminal to touch the lamp body in the region of the conductive layer such that the extremely thin layer structure results in contact being made during the coating process. The contact is thus made by the coating process itself, as a result of which further method steps for making the contact can be eliminated. For this reason, this solution is particularly cost-effective. The same method can also be used for the connecting terminal as that used for the other terminal.

The invention also relates to a production method for such a lamp.

One object of the invention is to provide a method which may be used to produce a lamp comparatively cost-effectively.

This is achieved according to the invention by the second line feed being applied to the lamp body in the form of a conductive layer using a vacuum coating method. The production of the conductive layer thus reduces the installation complexity which would be involved when fixing and making contact with a separate, second line feed. This has a favorable influence on the cost-effectiveness of the lamp.

Application of the layer using the vacuum coating technique shall be understood below to include all vacuum coating methods. A distinction needs to be drawn in particular between physical vapor deposition (PVD below) and chemical vapor deposition (CVD below). Sputtering, which is a PVD method, should be highlighted as a particularly suitable method. The use of said methods forms part of the prior art and is described, for example, in Kienel, Vakuumbeschichtung [Vacuum coating], Volume 2, Düsseldorf, 1995.

A particular improvement in the cost-effectiveness can be achieved when using the method according to the invention by, in addition to the conductive layer, at least one further layer being applied using the vacuum coating technique in one and the same manufacturing installation. The manufacturing installation is in this context understood to be a production device, which can be used to carry out two or more vacuum coating steps at once or in succession. In particular, the vacuum required for the vacuum coating processes in this case need only be built up once, as a result of which valuable time can be saved when carrying out the method steps. If sputtering is used as the vacuum coating method, two or more targets can be arranged in the coating chamber (recipient) and can be activated one after the other in order to apply different layers to the lamp body.

The invention is described in more detail below with reference to schematic exemplary embodiments, which do not mean that the invention is restricted to the exemplary embodiments in any way. In the drawing:

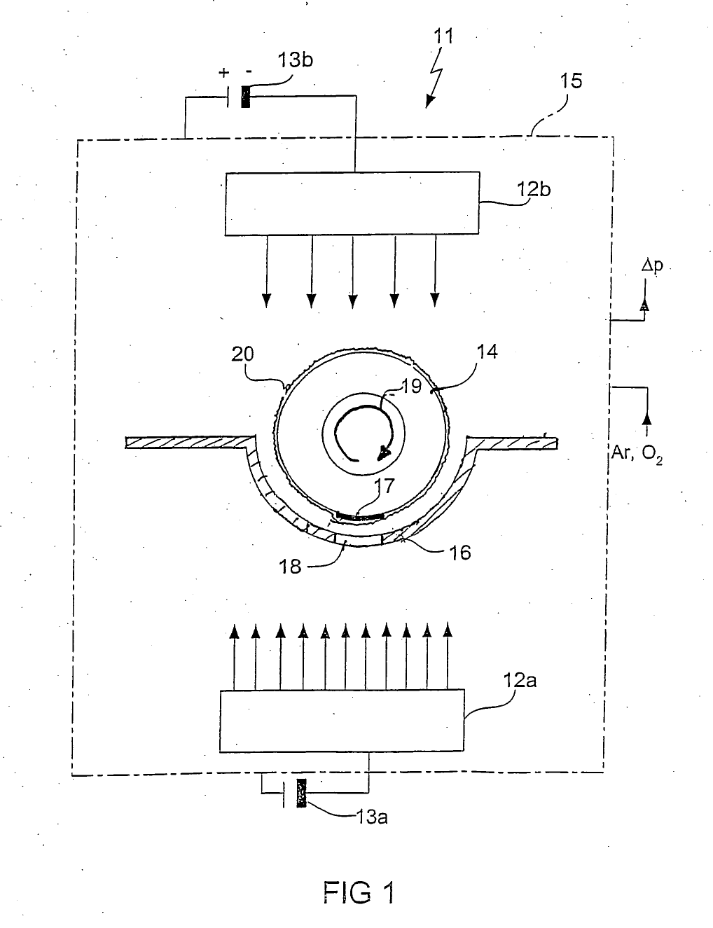

FIG. 1 shows the schematic design of a manufacturing installation for carrying out the method according to the invention in two or more coating steps,

FIG. 2 shows an exemplary embodiment of a high-pressure discharge lamp according to the invention for the headlamp of a motor vehicle, and

FIG. 3 shows a further variant according to the invention of the high-pressure discharge lamp.

FIG. 1 shows, schematically, a manufacturing installation 11, which is intended to be delimited by the dashed-dotted system limits. This manufacturing installation contains two targets 12a, b of different material, which can be activated independently of one another with the aid of voltage sources 13a, b. In this case, a lamp body 14 is positioned in the manufacturing installation such that a coating can be applied with the aid of the targets 12a, b.

The coating is applied using the so-called reactive sputtering method. For this purpose, a recipient 15, formed by the system limits of the manufacturing installation, is evacuated up to a defined pressure difference Δp, and the process gas, argon (Ar), is introduced. Then, the target 12a, which consists of a metal, has a voltage applied to it, as a result of which a plasma forms in the process gas. This results in metal ions being released from the target 12a, which propagate in the process gas in the direction of the arrow indicated and come into contact with the lamp body through a shadow mask 16 arranged between the target 12a and the lamp body 14 and form a metallic conductive layer 17 there. This conductive layer 17 is distinguished by its electrical conductivity, and its contour corresponds precisely to an opening 18 in the shadow mask 16. When the conductive layer has reached the required layer thickness, the sputtering process which is initiated with the aid of the target 12a is ended.

In the next process step, oxygen (O₂) is introduced into the process gas as the reactive component. Then, the target 12b, which is made of elemental cerium, is activated by a voltage being applied to it. According to the above-described sputtering process, as a result cerium ions are released from the surface of the target 12b, but are deposited as cerium oxide on the lamp body owing to the presence of the reactive component. The lamp body is in this case set in continuous rotation corresponding to the arrow 19 indicated, causing a uniform insulating layer 20 of cerium oxide to be built up over the entire circumference. This layer thus also covers the conductive layer 17 and therefore causes the conductive layer to be electrically insulated as the name of the layer would suggest.

A further object of the insulating layer is, however, the absorption of the UV light which is produced within the lamp body during operation of the lamp. The insulating layer is therefore arranged over the entire circumference of the lamp body, it being possible to achieve both functions of the layer by carrying out a single process step during vacuum coating.

FIG. 2 shows a high-pressure discharge lamp 21, as can be installed in a headlamp of a motor vehicle which is not shown in any more detail. An indicated bayonet fitting 22 is used for installation purposes, with the aid of which the high-pressure discharge lamp can be fixed in a headlamp of a motor vehicle in a manner which is not shown in any more detail. In this case, contacts 23a, b, which are integrated in a base 24 of the lamp 21, come into contact with a power supply (not shown) of the motor vehicle, by means of which the lamp can be caused to luminesce.

For this purpose, a luminous element 25 arranged in the lamp body 14 is connected, via a first line feed 26 and a second line feed 27, to an internal energy supply which is connected to the contacts 23a, b. The energy supply is formed by a high-voltage generator (not shown in any more detail) in the base 24 of the lamp, of which only one coil former 29 can be seen, which contains the windings required for transforming the voltage.

The luminous element 25 comprises an inner tube 30, which forms the so-called burner for a pressurized gas. The luminous element is caused to luminesce by two electrodes 31a, b, which are connected to the ends of the inner tube, where they form a terminal 28a at a first end 32 of the lamp body and another terminal 28b at a second end 33 of the lamp body. One terminal 28a is connected directly to a secondary winding on the coil former 29.

The other terminal 28b is bent back at the second end 33 of the lamp body 14 such that it directly touches the surface of the lamp body. From there, the conductive layer 17 in the form of a second line feed extends up to a connecting terminal 35, which protrudes from the base 24 and is bent back such that the end of the connecting terminal touches the lamp body. The conductive layer 17 was applied after the ends of said terminals 28b, 35 had been bent back such that it also extends over part of these terminals. This overlapping ensures that electrical contact is made.

Another end of the connecting terminal 35 leads to the secondary winding on the coil former 29. The coil former 29 also has a primary winding, which is supplied with an electrical voltage via the contacts 23a, b (not shown in any more detail).

FIG. 3 shows another variant of the high-pressure discharge lamp 41, components corresponding to those in FIG. 2 being provided with identical reference numerals. In contrast to this, however, in order to bring the conductive layer 17 into contact with the other terminal 28b and the connecting terminal, another connecting technique is used: The terminal 28b is brought into contact with the conductive layer with the aid of a soldered joint 37b. The conductive layer 17 in this case forms a soldering surface which is highly suitable for application of the solder. The other terminal 28b must be bent toward the conductive layer for the purpose of joining them by means of soldering, it not being necessary for them to touch, since a gap remaining between the terminal 28b and the conductive layer 17 can be bridged by the solder.

The soldered joint 37b may also be replaced by a welded joint (not shown). Instead of the solder, a weld spot in this case forms the electrical contact between the conductive layer 17 and the other terminal 28b, which is produced by fusing these two components.

Electrical contact is made between the connecting terminal 35 and a clamping ring 38, which is injected into a plastic body 39 of the base 24, via a soldered joint 37a. This clamping ring improves the fixing of the lamp body 14 in the base, direct contact being made between the clamping ring and the lamp body. A point of contact 40 between these two components is thus formed, the conductive layer 17 reaching down to this point of contact on the lamp body 14, which ensures that electrical contact is made.

The lamp shown in FIG. 3 further differs from the lamp shown in FIG. 2 by the fact that, in addition to the conductive layer 17, the insulating layer 20 (cf. FIG. 1) is applied which completely surrounds the lamp body 14. This insulating layer also covers the conductive layer 17, which brings about insulation preventing a flashover owing to the high voltage present. In the remaining region of the lamp body 14, the insulating layer 20 improves the absorption by the lamp body of UV radiation. This protects plastic components of the motor vehicle against decomposition which would be accelerated by the effect of UV radiation.

Alternatively, the insulating layer may also be in the form of an infrared reflection layer. This makes it possible for the burning temperature of the burner formed by the inner tube 30 to be increased, which improves the light output of the lamp.

The representation of the insulating layer 20 as a wavy line is intended to improve the clarity of the drawing and is no indication of the surface structure of the layer or of its adhesion to the lamp body 14. Beneath this layer, a very thin cerium oxide layer applied directly to the lamp body must be imagined. Also, the conductive layer 17 represented by a thick black line is illustrated considerably enlarged, i.e. is not to scale.

1.-11. (cancelled)

12. A high-pressure discharge lamp, comprising:
a lamp body surrounding a luminous element, said lamp body having two terminals and being filled with a discharge gas;
a first line feed in said lamp body and extending to one of said two terminals; and
a second line feed that is a vacuum coated conductive layer extending along an exterior of said lamp body to a second of said two terminals.

13. The lamp of claim 12, wherein said conductive layer comprises a metal that is passivated in air.

14. The lamp of claim 13, wherein said metal is aluminum.

15. The lamp of claim 12, further comprising an electrical insulating layer on said conductive layer.

16. The lamp of claim 15, wherein said insulating layer is also on parts of said lamp body not having said conductive layer thereon.

17. The lamp of claim 16, wherein said insulating layer covers all of said lamp body.

18. The lamp of claim 15, wherein said insulating layer is an infrared reflection layer.

19. The lamp of claim 12, further comprising a base holding said lamp body and a connecting terminal in said base, and wherein said conductive layer extends from said connecting terminal to said second of said two terminals.

20. The lamp of claim 19, further comprising one of a solder and welded joint connecting said conductive layer to said connecting terminal.

21. The lamp of claim 12, further comprising one of a solder and a welded joint connecting said conductive layer to said one of said two terminals.

22. The lamp of claim 12, wherein said second of said two terminals extends onto the exterior of said lamp body and said conductive layer overlaps a part of said second of said two terminals that extends onto the exterior of said lamp body.

23. The lamp of claim 12, wherein said vacuum coated conductive layer is directly on the exterior of said lamp body.

24. A method of making a high pressure discharge lamp having a lamp body surrounding a luminous element, the lamp body having two terminals and being filled with a discharge gas, the method comprising the steps of:
extending a first feed line to one of the two terminals; and
vacuum coating a conductive layer onto an exterior of the lamp body, the conductive layer extending to a second of the two terminals.

25. The method of claim 24, wherein the vacuum coating step comprises reactive sputtering.

26. The method of claim 25, wherein the conductive layer is sputtered through an opening in a shadow mask.

27. The method of claim 24, further comprising the step of vacuum coating a further layer on the conductive layer in a same chamber as used in the step of vacuum coating the conductive layer.

28. The method of claim 27, wherein the further layer covers all of the lamp body.

29. The method of claim 27, wherein the lamp body is rotating during vacuum coating of the further layer.

30. The method of claim 24, further comprising the step of soldering or welding the conductive layer to the second of the two terminals.

31. The method of claim 24, further comprising the steps of extending a part of the second of said two terminals onto the exterior of the lamp body and applying the conductive layer to the part of the second of the two terminals that extends onto the exterior of the lamp body during the vacuum coating step.
